(19) United States
(12) Patent Application Publication
(10) Pub. No.: US 2024/0247121 A1
(43) Pub. Date: Jul. 25, 2024

(54) INTUMESCENT FLAME RETARDANT COATING FORMULATIONS FOR MASS TIMBER SUBSTRATES

(71) Applicant: ADVANCED POLYMERICS, INC., Salem, NH (US)

(72) Inventor: Stephen JEWITT, Wenham, MA (US)

(21) Appl. No.: 18/421,164

(22) Filed: Jan. 24, 2024

Related U.S. Application Data
(60) Provisional application No. 63/481,430, filed on Jan. 25, 2023.

(51) Int. Cl. C08J 7/05; B05D 7/08; C09D 5/18; C09D 7/61; C09D 161/28

(52) U.S. Cl. CPC C08J 7/05; B05D 7/08; C08J 7/08; C09D 5/185; C09D 7/61; C09D 161/28; B05D 2203/20

(57) ABSTRACT

Intumescent flame-retardant formulations and their application to mass timber substrates.

### FIELD

The present invention is directed at intumescent flame-retardant formulations and their application to mass timber substrates.

### BACKGROUND

Mass timber is a construction material that encompasses glued and compressed timbers of various sizes and lengths that can bear loads greater than its individual elements. Mass timber includes what is typically termed as cross-laminated timber (CLT), glue-laminated (glulam or GLT) beams, laminated veneer lumber (LVL), nail-laminated timber (NLT), or dowel-laminated timber (DLT).

Mass timber is inherently combustible and therefore can act as a fuel in a building fire and prolong the duration of aforesaid fire. Solid timber is also inherently combustible and forms a char layer on exposure to fire, which partially protects the underlying wood. To meet various building codes and fire codes, mass timber often has to be insulated from the heat-source using a noncombustible material, either by an inert material such as gypsum building board or batts of mineral wool applied to the outer surface.

Mass timber is typically manufactured on an industrial scale using specialized machines, so that relatively small timber elements are glued or otherwise attached to another adjacent element to form a laminated structure. Although the process produces a material which has a relatively high load bearing capacity, it relies on the glue layer remaining relatively strong during the progress of a fire which may reach temperatures in excess of 1200° F. Nail laminated and dowel laminated timber are less prone to failure but still require protection from the heat of the fire. Some glue-laminated and cross-laminated timber is not glued, or is only partially glued, on the face laminates to facilitate relatively easy handling of the composite and its passage through the press which helps to form a stronger material. The press is used to both spread the adhesive more evenly and to ensure intimate union of the individual sticks of lumber. However, the lack of glue in these outer laminated layers can allow some movement of the laminates when heated by fire and allows hot gasses into lower layers of material than would be normal in the case of solid structural timbers.

Intumescent flame retardants act through the formation of an expanded insulating layer of non-combustible, flame-retardant material that forms under the action of heat, which insulates the underlying material to be protected from heat and the ingress of oxygen and hence prevents or delays the burning of combustible material or prevents or at least delays the heating or charring of load-bearing and non load-bearing components through the transfer of heat.

Accordingly, a need remains to provide for a mass timber product having a cross-laminated type structure, and in particular a product that is glue laminated, that has improved flame retardance and fire resistance characteristics and which also retains the visual aesthetic appearance of the wood components.

### BRIEF DESCRIPTION OF THE DRAWINGS

FIG. 1 is a perspective view of a mass timber product having a cross-laminated type structure.

FIG. 2 is a partial end view of FIG. 1.

### DETAILED DESCRIPTION

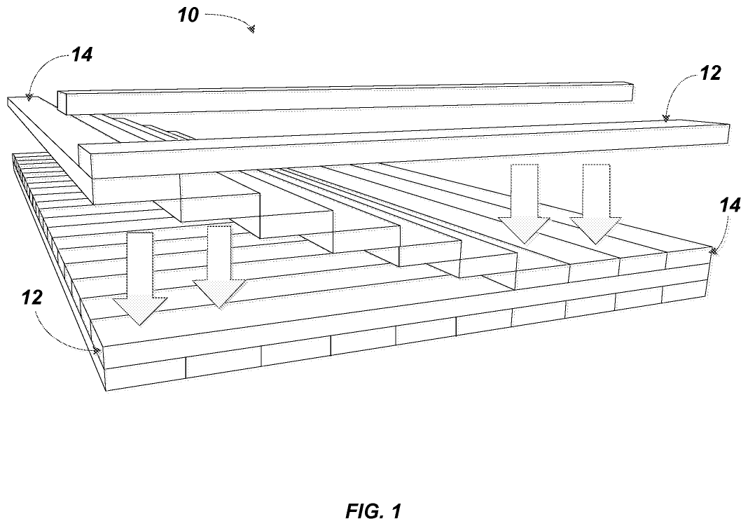

FIG. 1 illustrates one preferred example showing in perspective view a mass timber product 10 being formed having a cross-laminated type structure. As can be seen, a plurality of first lumber components 12 are cross laminated with a plurality of second lumber components 14 to provide for a plurality of layers of such cross laminated components.

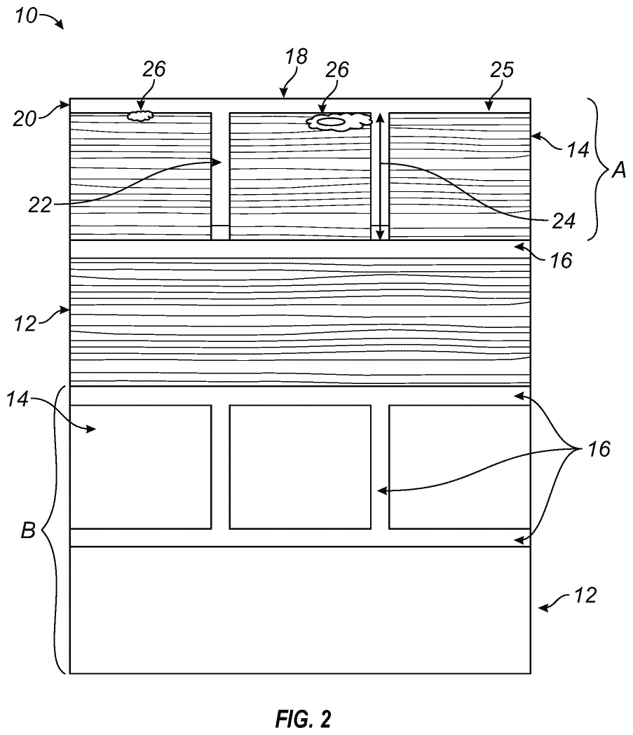

FIG. 2 illustrates in partial end view of FIG. 1 the application of an intumescent coating 18 herein on the outer (face) portion “A” of cross-laminated timber product 10 that relies upon an underlying adhesive 16 (i.e. glue-laminated timber). More specifically, the cross-laminated timber includes a plurality of lumber components 12 that are cross-laminated with a plurality of lumber components 14 via use of a cross-laminating timber (CLT) adhesive 16. While there may be additional lower layers “B” to the cross-laminated timber, that utilize the CLT adhesive 16, FIG. 2 is a partial end view emphasizing in relatively greater detail the outer portion “A” of the of lumber components 12 and 14. The CLT adhesive 16 is typically formulated to provide a relatively high glass transition temperature and preferably sourced from, e.g., moisture cured polyurethanes based on isocyanate prepolymer. The CLT adhesive 16 may also be sourced from certain melamine resins, phenol-resorcinol-formaldehyde resins and resorcinol resins.

As can also be seen in FIG. 2, preferably, one now applies to the outer face portion “A” of the cross-laminated timber 10 an intumescent flame retardant formulation 18 that also can act as an adhesive. Preferably, before application of the intumescent flame retardant formulation 18, the surface 25 of the mass timber product 10 is sanded to reduce surface roughness. As discussed more fully herein, the intumescent flame retardant formulation is one that is preferably sourced from thermoplastic or thermoset type polymeric resins and serves as adhesive for the lumber components of the cross-laminate timber.

The intumescent flame retardant formulation 18 preferably provides a clearcoat layer 20 over all or a portion of the outer face portion that preferably has a thickness in the range of 0.5 mm to 5.0 mm including all individual values and increments therein. For example, a thickness range of 0.5 mm to 1.5 mm. In addition, the intumescent flame retardant formulation fills-in all or a portion of the relatively vertical cavities 22 that are present in the outer face portion “A” between the cross-laminated timber components 14. The intumescent flame retardant then serves to adhere and bond timber components 14 together. The relatively vertical cavities 22 preferably have a height in the range of 15.0 mm to 51.0 mm, including all values and increments therein, as shown by arrow 24. The thickness of the intumescent flame retardant formulation 18 between timber components 14 preferably is in the range of 0.1 mm to 5.0 mm, including all values and increments therein. It is worth noting that the thickness of the intumescent flame retardant formulation between the timber components is contemplated to be relatively low, since the intumescent formulation between the timber components can be absorbed into the timber surface or reduced in thickness due to the pressing together of the timber components 14. In addition, it can be seen that the intumescent flame retardant formulation may preferably fill-in other voids or defects 26 (e.g., knots or burrs) present in the outer surface of the lumber components 14.

As may therefore now be appreciated from FIGS. 1 and 2, the outer face portion “A” of the cross-laminated timber 10 includes one or a plurality of lower portions “B.” Such lower portions “B” may typically rely upon cross-laminating adhesive 16 that does not contain any intumescent flame retardant. Accordingly, the intumescent flame retardant formulation 18 herein is preferably applied only as a coating to the outer face portion “A” of the cross-laminated timber 10 as illustrated in FIG. 1. Preferably, such coating (which also fills all or a portion of the vertical cavities 22) may be applied by vacuum bagging and may also be preferably cured (solidified) by application of radio-frequency (RF) radiation heating and/or infrared heating. The preferred use of RF radiation and/or infrared heating is contemplated to reduce the drying time after application of the intumescent flame retardant formulation to, e.g., the sanded surface 25. The use of RF radiation and/or infrared heating is contemplated to be particularly useful when the flame retardant intumescent formulation 18 is a thermoset formulation where one desires to promote crosslinking during cure.

The intumescent flame retardant formulation that is utilized herein is such that it is preferably providing a clearcoat formulation, which is reference to the feature that it is relatively clear and allow for the transmission of light waves in the wavelength range of 380 nanometers (nm) to 780 nm. Accordingly, when applied to the mass timber substrate herein, the clearcoat that is formed allows for the typical consumer to see through the clearcoat and observe the underlying wood grained surface of the lumber components 14. See again, FIG. 1. The aforesaid flame retardant formulation can also be tinted with transparent pigments to provide additional color to the mass timber elements, such that they can resemble a different species of wood to that actually used.

The intumescent flame retardant/adhesive formulation herein is also one that is preferably halogen-free and as noted above, may be either thermoplastic or thermoset (cross-linked). The intumescent flame retardant/adhesive formulation herein also preferably acts through the formation of an expanded insulating layer of relatively non-combustible, flame-retardant material that forms under the action of heat, which insulates the underlying material (mass-timber) and cross-laminating adhesive 16 to be protected from heat and the ingress of oxygen and hence prevents or delays the burning of combustible material (e.g., cross-laminating timber adhesive) or prevents or at least delays the heating or charring of load-bearing and non load-bearing components through the transfer of heat.

Certain manufacturing equipment can preferably apply the intumescent flame retardant formulation herein using, e.g., an edge-glue mechanism which applies the intumescent flame retardant formulation, also acting as an adhesive to the outer portion of the cross-laminated timber before the entire cross-laminated timber is pressed and cured. The intumescent flame retardant formulation would preferably be applied (in liquid form) to the outer surface sticks of the mass timber after the assembly has been pressed and preferably passed through a sanding stage to eliminate surface imperfections and excess glue from lower layers. A similar effect can be achieved by introducing a predetermined amount of the preferred intumescent flame retardant formulation (in liquid form) onto the outer surface of the mass timber, during or after the manufacturing process, and applying a vacuum to the surface to expel any trapped air within the surface laminates of the mass timber. The vacuum can be preferably applied by employing a vacuum infusion process, sometimes called vacuum bagging, as used in the manufacturing of glass or carbon fiber composites. Preferably, and as alluded to above, the intumescent flame retardant formulation can be heated by radio frequency (RF) radiation or infra-red radiation to cure or partially cure the formulation in-situ before the vacuum is released. Alternatively, the mass timber can preferably be placed in a vacuum chamber and vacuum applied externally until all the air is expelled.

Intumescent coating materials applied in this way can preferably be repaired or maintained on-site, or a topcoat can be applied to enhance the flame spread and flame-retardant properties of the outer surface or to enhance the visual appearance of the surface or to reduce water vapor transmission.

The cross-laminated lumber made according to this invention is therefore contemplated to show improved reaction to fire in a real-life fire or when tested according to the established fire testing regimes such as ASTM E119 (UL263, NFPA/ANSI 251, UBC 7-1 ISO 834, BS476-20 EN 1363, and BS EN 1364 and other global fire testing standards). Structural elements such as columns, walls and ceilings are preferably tested under load before using in a structural design. Load bearing abilities are contemplated to be retained longer due to a combination of the intumescent charring and the natural charring of timber after the noncombustible intumescent char is eroded away.

One preferred intumescent flame-retardant clearcoat formulation herein is described in International Publication Number WO2021/037955, whose teachings are incorporated by reference. Such preferred clearcoat intumescent formulation herein therefore preferably comprises a formulation containing 20% to 88.5% by weight of an aqueous synthetic resin formulation, 10% to 60% by weight of a phosphoric partial ester, 0.5% to 20% by weight of a polyol and 1% to 30% by weight of further ingredients.

Reference to the aqueous synthetic resin formulation is preferably a nitrogen-containing synthetic resin formulation. More preferably, a melamine-formaldehyde resin and/or a urea-formaldehyde resin. The aqueous synthetic resin may also preferably include an etherified melamine-formaldehyde resin and/or an etherified urea-formaldehyde resin. The melamine resins are preferably reaction products of melamine with formaldehyde in a molar ratio of 1:1 to 1:6 (melamine:formaldehyde). The melamine-formaldehyde resins are also preferably etherified with alcohols having a chain length of 1 to 20 carbon atoms.

The phosphoric partial ester is preferably a composition corresponding to a mixture of mono- and diesters of orthophosphoric acid with one or more polyols, where the average hydroxyl group content of these polyols is at least 40% by weight (calculated as the molecular weight of the hydroxyl groups divided by the total molecular weight of the polyols times 100%), the molar monoester/diester ratio does not exceed 12:1 and the phosphorus content of the mixture is at least 10% by weight.

The phosphoric partial ester is more preferably a composition corresponding to a mixture of optionally carboxylic anhydride-modified mono- and diesters of orthophosphoric acid with one or more polyols, where the average hydroxyl group content of these polyols is at least 40% by weight, the molar monoester/diester ratio does not exceed 12:1 and the phosphorus content of the mixture is at least 10% by weight.

The polyol is preferably pentaerythritol, dipentaerythritol, tripentaerythritol and/or polycondensates of pentaerythritol and/or mixtures of pentaerythritol-based esters, glycerol, oligomeric glycerol, xylitol, sorbitol, mannitol, isomalt, lactitol, glucitol, threitol, erythritol, arabitol, inositol, glucosamine, polyvinyl acetate, polyvinyl alcohol and ethylene oxide-propylene oxide polyols. The polyol is preferably sorbitol.

The phosphoric partial ester preferably derives from at least 2 and especially from 2 to 4 polyols having an average hydroxyl group content (calculated as the molecular weight of the hydroxyl groups divided by the total molecular weight of the polyols times 100%) of at least 40% by weight, preferably at least 45% by weight. It is also possible to use one or more polyols having a hydroxyl group content below 40% by weight in the polyol mixtures, in which case preferably not more than 15% of all polyol hydroxyl groups present originate from such polyols.

The other ingredients in the intumescent flame retardant formulation herein include dispersants, fillers, curing agents, thixotropic agents, plasticizers, acid donors, further flame retardants, surface auxiliaries and/or binders. It is also contemplated that one may include hydrophobic agents, biocides and/or pesticides as well as pigments or tinting pastes.

### WORKING EXAMPLES

Reference is made to the following non-limiting working examples of the intumescent formulations that may be used herein for application to the cross-laminated timber herein. In each of the Examples below, both components Part 1 and Part 2 are blended together and applied to the wooden substrate (cross-laminated timber) by edge-gluing machine or by curtain coating or by spray.

### Example 1

| PART 1 | | | |
|---|---|---|---|
| Maprenal MF 920 WA | MF Resin 75% in water. | 481.3 | g |
| Chinafill 100 | Hydrous clay | 74.2 | g |
| Sorbitol solution 70% | | 92.75 | g |
| Hypersal XT 782 | Polyglycol alkyl ether | 0.29 | g |
| | derivative and fatty | | |
| | acid derivate, sulfonated | | |
| Byk 066 | Defoamer | | |
| Firebreak ZB | Zinc Borate fire | 1 | g |
| | Retardant | | |
| ATH HN532 or | Aluminum Trihydrate | 2 | g |
| ATH 434 | flame retarder | | |
| Acticide MBS | In can preserver | 0.25 | g |
| Fullstoff FG400/040 | Glass fiber | 1 | g |
| Acrysol SCT-275 | Thickener/Rheology | 0.5 | g |
| | Modifier | | |
| Total 1 | | 653.29 | g |
| PART 2 | | | |
| Exolit 855 | Phosphate Resin | 328 | g |
| PTSA (P- | Catalyst | 23.46 | g |
| toluenesulphonic Acid) | | | |
| Total 1&2 | | 1004.46 | g |

### Example 2

| PART 1 | | | |
|---|---|---|---|
| Maprenal MF 920 WA | MF Resin 75% in water. | 481.3 | g |
| Chinafill 100 | Hydrous clay | 74.2 | g |
| Sorbitol solution 70% | | 92.75 | g |
| Hypersal XT 782 | Polyglycol alkyl ether | 0.29 | g |
| | derivative and fatty | | |
| | acid derivate, sulfonated | | |
| Byk 066 | Defoamer | | |
| Firebreak ZB | Zinc Borate fire | 1 | g |
| | Retardant | | |
| ATH HN532 or | Aluminum Trihydrate | 2 | g |
| ATH 434 | flame retarder | | |
| Acticide MBS | In can preserver | 0.25 | g |
| SPX0048 Graphene | Graphene | 1 | g |
| Acrysol RM8 | Thickener/Rheology | 0.5 | g |
| | Modifier | | |
| Total 1 | | 653.29 | g |
| PART 2 | | | |
| Exolit 855 | Phosphate Resin | 328 | g |
| PTSA (P- | Catalyst | 23.46 | g |
| toluenesulphonic Acid) | | | |
| Total 1&2 | | 1004.46 | g |

### Example 3

| PART 1 | | | |
|---|---|---|---|
| Maprenal MF 920 WA | MF Resin 75% in water. | 481.3 | g |
| Chinafill 100 | Hydrous clay | 74.2 | g |
| Sorbitol solution 70% | | 92.75 | g |
| Hypersal XT 782 | Polyglycol alkyl ether | 0.29 | g |
| | derivative and fatty | | |
| | acid derivate, sulfonated | | |
| Byk 066 | Defoamer | | |
| Firebreak ZB | Zinc Borate fire | 1 | g |
| | Retardant | | |
| ATH HN532 or | Aluminum Trihydrate | 2 | g |
| ATH 434 | flame retarder | | |
| Acticide MBS | In can preserver | 0.25 | g |
| Fullstoff FG400/040 | Glass fibre | 1 | g |
| Acrysol RM8 | Thickener/Rheology | 0.5 | g |
| | Modifier | | |
| Total 1 | | 653.29 | g |
| PART 2 | | | |
| Exolit 855 | Phosphate Resin | 328 | g |
| PTSA (P- | Catalyst | 23.46 | g |
| toluenesulphonic Acid) | | | |
| Total 1&2 | | 1004.46 | g |

As can now be appreciated from the above, the present invention relates to method of forming a cross-laminated timber product comprising a cross-laminated timber structure having a plurality of first lumber components that are cross-laminated with a plurality of second lumber components therein providing a plurality of layers of said first and second lumber components The cross-laminated timber includes an outer face portion formed from the first lumber components and include relatively vertical cavities between the first lumber components. One may then apply an intumescent flame retardant as a coating to all or a portion of the outer face portion and within all or a portion of the relatively vertical cavities between said first lumber components.

In product form, the present invention relates to a cross-laminated timber product comprising cross-laminated timber having a plurality of first lumber components that are cross-laminated with a plurality of second lumber components therein providing a plurality of layers of the first and second lumber components. The cross-laminated timber includes an outer face portion formed from the first lumber components including relatively vertical cavities between the first lumber components. An intumescent flame retardant coating is present on the outer face portion and within all or a portion of the relatively vertical cavities between said first lumber components.

What is claimed is:

1. A method of forming a cross-laminated timber product comprising:
a. supplying a cross-laminated timber having a plurality of first lumber components that are cross-laminated with a plurality of second lumber components therein providing a plurality of layers of said first and second lumber components;
b. said cross-laminated timber including an outer face portion formed from said first lumber components including relatively vertical cavities between said first lumber components;
c. applying an intumescent flame retardant formulation as a coating to all or a portion of said outer face portion and within all or a portion of said relatively vertical cavities between said first lumber components.

2. The method of claim 1, wherein said intumescent flame retardant formulation comprises thermoplastic or thermoset polymeric resin.

3. The method of claim 1, wherein said intumescent flame retardant coating is exposed to radio frequency (RF) radiation and/or infrared heating.

4. The method of claim 1, wherein prior to step (c), said outer face portion of said cross-laminated timber is sanded.

5. The method of claim 1, wherein said intumescent flame retardant coating comprises a clearcoat formulation.

6. The method of claim 1, wherein said intumescent flame retardant coating comprises a tinted clearcoat formulation.

7. The method of claim 1, wherein said intumescent flame retardant coating is halogen free.

8. The method of claim 1, wherein said intumescent flame retardant coating comprises a formulation containing 20% to 88.5% by weight of an aqueous synthetic resin formulation, 10% to 60% by weight of a phosphoric partial ester, 0.5% to 20% by weight of a polyol and 1% to 30% by weight of further ingredients.

9. The method of claim 8, wherein said aqueous synthetic resin formulation comprises a nitrogen-containing synthetic resin.

10. The method of claim 9, wherein said nitrogen-containing synthetic resin comprises a melamine-formaldehyde resin and/or a urea-formaldehyde resin.

11. The method of claim 8, wherein said phosphoric acid partial ester comprises a mixture of mono- and diesters of orthophosphoric acid with one or more polyols, where the average hydroxyl group content of these polyols is at least 40% by weight, the molar monoester/diester ratio does not exceed 12:1 and the phosphorus content of the mixture is at least 10% by weight.

12. The method of claim 8, wherein said polyol is pentaerythritol, dipentaerythritol, tripentaerythritol and/or polycondensates of pentaerythritol and/or mixtures of pentaerythritol-based esters, glycerol, oligomeric glycerol, xylitol, sorbitol, mannitol, isomalt, lactitol, glucitol, threitol, erythritol, arabitol, inositol, glucosamine, polyvinyl acetate, polyvinyl alcohol and ethylene oxide-propylene oxide polyols.

13. The method of claim 8, wherein said other ingredients comprise dispersants, fillers, curing agents, thixotropic agents, plasticizers, acid donors, further flame retardants, surface auxiliaries, binders, hydrophobic agents, biocides, pesticides, pigments or tinting pastes.

14. A cross-laminated timber product comprising:
a. a cross-laminated timber having a plurality of first lumber components that are cross-laminated with a plurality of second lumber components therein providing a plurality of layers of said first and second lumber components;
b. said cross-laminated timber including an outer face portion formed from said first lumber components including relatively vertical cavities between said first lumber components;
c. an intumescent flame retardant coating on said outer face portion and within all or a portion of said relatively vertical cavities between said first lumber components.

15. The cross-laminated timber product of claim 14, wherein said intumescent flame retardant formulation comprises thermoplastic or thermoset polymeric resin.

16. The cross-laminated timber product of claim 14, wherein said intumescent flame retardant formulation comprises a clearcoat formulation.

17. The cross-laminated timber product of claim 14, wherein said intumescent flame retardant formulation comprises a tinted clearcoat formulation.

18. The cross-laminated timber product of claim 14, wherein said intumescent flame retardant formulation is halogen free.

19. The cross-laminated timber product of claim 14, wherein said intumescent flame retardant coating comprises a formulation containing 20% to 88.5% by weight of an aqueous synthetic resin formulation, 10% to 60% by weight of a phosphoric partial ester, 0.5% to 20% by weight of a polyol and 1% to 30% by weight of further ingredients.

20. The cross-laminated timber product of claim 19, wherein said phosphoric acid partial ester comprises a mixture of mono- and diesters of orthophosphoric acid with one or more polyols, where the average hydroxyl group content of these polyols is at least 40% by weight, the molar monoester/diester ratio does not exceed 12:1 and the phosphorus content of the mixture is at least 10% by weight.
